(19) United States
(12) Patent Application Publication
(10) Pub. No.: US 2005/0033559 A1
(43) Pub. Date: Feb. 10, 2005

(54) Construction method and cad system

(76) Inventor: Stefan Wander, Helmstadt (DE)

Correspondence Address: Douglas R Hanscom;Jones Tullar & Cooper, Eads Station, PO Box 2266, Arlington, VA, 22202, US

(21) Appl. No.: 10/495,122

(22) PCT Filed: Nov. 21, 2002
(86) PCT No.: PCT/DE02/04280

(30) Foreign Application Priority Data
Nov. 22, 2001 (DE) 101 57 269.7

(51) Int. Cl. G06F 17/50

(52) U.S. Cl. 703/1

(57) ABSTRACT

The invention relates to a method for constructing a machine composed of several subassemblies, characterised as follows:—a substitute geometric element (EGEi), which provides a simplified representation of the object to be constructed is first defined for at least one object to be constructed; information concerning the geometry of the object to be constructed is assigned to the substitute geometric element (EGEi); a more detailed object is constructed using the substitute geometric element (EGEi) and/or the information assigned thereto.

### FIELD OF THE INVENTION

The present invention is directed to CAD systems for supporting the design of a machine composed of several structural groups.

### BACKGROUND OF THE INVENTION

Conventional CAD systems include one or several work stations each with at least one input device for inputting a description of the layout of an object to be designed, and each with a display device for showing a representation of the object calculated from the description of the layout. A processor for calculating the representation of the object from the description of the layout can be assigned to a single work station or to several work stations together.

The input of the description of the layouts takes place in steps. The user selects one layout element from a plurality of layout elements offered for selection by the CAD system, and whose graphic representation it is capable of displaying, with the aid of an input device and specifies its position and orientation with respect to the object to be designed, with respect to its size, and also with respect to other parameters, if required.

This working method of conventional CAD systems demands from a design engineer utilizing such a system that he starts his design work with the smallest elements and assembles complex objects step by step from such small units. Such a working method is ill suited to complex design jobs. If it is intended to construct a machine composed of a plurality of structural components, the above-described working method of conventional CAD systems first requires the construction or design of the individual structural components in detail before it is possible to assemble their individual design plans into a plan for construction or designing the entire machine. If difficulties arise in the course of this assembling, it might become necessary to make design changes to the individual structural components. Such changes often entail large amounts of time and cost. Moreover, processing the design plan of the entire machine by the use of such a CAD system requires extremely long times, because the number of the layout elements which must be taken into consideration in the calculation of a graphic representation is extremely large.

Conventional CAD systems attempt to overcome this drawback. In case a very detailed representation of an object to be designed is to be shown, this is simplified by so-called faceting. In the course of this faceting, graphic objects, whose exact graphic representation on a display device requires a large calculating outlay, such as, for example, constantly bent curves, circles, ellipses, etc., are replaced by polygonal progressions in the representation. However, in some cases, this solution is unsatisfactory, since it is not easily possible for a user to determine whether such a polygonal progression lies within or outside of the boundaries of a body which it represents, and therefore a positive statement regarding whether machine elements represented in this simplified way are in engagement in a desired way or are safely spaced apart from each other, is not possible.

A further disadvantage of faceting is that no “real” graphic object corresponds to the polygonal progression visible in the graphic representation which real graphic object could be selected by the user, for example, by pointing with a cursor of a visual display device. While many CAD systems for “real”, i.e. non-simplified graphic objects, support aid functions, such as drawing a perpendicular or laying a tangent at the surface of the object, a check regarding overlap of another object, distance calculations, etc., these functions are not available for a polygonal progression obtained by faceting.

If for these reasons a design engineer selects a detailed representation, he must accept correspondingly long calculating times for generating the representation, even if he is only interested in individual details thereof.

DE 199 59 617 A1 describes a design system for designing new structural components. In this prior system simplified structural space surroundings are made available, which fix the available space for the design of the new structural components. No statement is made regarding the layout of the component to be newly designed, a simplified replacement body of the component in particular does not exist.

U.S. Pat. No. 4,994,989 and DE 199 40 625 A12 form simplified replacement layout elements from complex layout elements for a more rapid representation.

### SUMMARY OF THE INVENTION

The object of the present invention is directed to the creation of CAD systems for supporting the design of a machine composed of several structural groups.

In accordance with the present invention, this object is attained by the provision of a CAD system for supporting the design of a machine composed of several structural groups. A replacement layout element, which shows the object to be designed in simplified form, is selected. Information regarding the geometry of the object is assigned to this replacement layout. Internal information for designing the object, and external information for connecting it to other objects is also assigned to the replacement layout element. A more detailed object is constructed. A group of layout elements is assigned to each replacement layout element which is filled with layout elements in the course of the design of the structural component.

Because of the possibility provided by this system to selectively represent groups of layout elements either in detail or by the use of a replacement layout element in the course of calculating a graphic representation of the object to be designed, the calculating outlay for calculating a graphic representation can be clearly reduced without it becoming necessary, in connection with an area of the object of special interest, to make cuts in the wealth of data by use of which this area is represented. For example, this system makes it possible for a design engineer, drafting an individual structural component of a compound machine, to observe a detailed representation of his structural component in spatial connection with simplified representations of adjoining structural components. This will allow the design engineer to obtain a quick insight into whether a change made in the design is compatible with the geometric properties of adjoining structural components.

The system in accordance with the present invention preferably supports the assignment of layout elements to a group by the user. This makes it possible for a user to fix the group membership of individual layout elements with respect to taking the layout and mode of functioning of the machine to be designed into consideration and in this way to connect cooperating layout elements, for example, to form a group. These are viewpoints which cannot be easily taken into consideration in case of an automatic assignment by the system, for example from the viewpoint of spatial closeness.

The CAD system supports the assignment of each individual already input layout element to a group by the user for forming a group or to change it. Another possibility, which can be realized in the same CAD system for assigning layout elements to a group, is the opening of the group by a user with the result that layout elements, which are input while the group is open, are automatically assigned to the respective group by the system.

The assignment of a replacement layout element to a group can also be suitably performed by a user. In this way, it is easily possible to give the replacement layout element those layout characteristics which are essential for the interaction of a structural group represented by the replacement layout element with adjoining structural groups. This lets a designer, who is working on a first structural group of a complex machine, to represent only the first structural group in detail, and represent adjoining groups in the form of their replacement layout elements, so that, with short calculating times for the generation of a representation, the designer can still see those details of adjoining structural groups which are relevant for the interaction with the first structural group he is working on.

In accordance with a particularly preferred embodiment of the present invention, the CAD system supports the creation of groups by simply inputting a replacement layout element, or by designating a replacement layout element which had already been input, to be the replacement layout element. This property considerably simplifies the design by use of the top-down method and the work-related design. Thus, it is sufficient to input replacement layout elements, or layout elements, which are later redefined as replacement layout elements, in a first design work step in order to initially roughly fix the layout of a machine to be designed, wherein one replacement layout element can correspond to respective structural groups of the machine. A group of layout elements, which, at the time of the input or of the definition of the replacement layout element, can still be empty, is assigned to each one of these replacement layout elements. In the course of the design of the respective structural group the group is filled with layout elements. In this case, each one of the layout elements input into the group can, in turn, be a replacement layout element for a structural sub-group, or can be defined as such a one in the course of the design process.

In this way, the complete machine can already be represented in its entirety in a rough layout by the use of the replacement layout element at the start of the design work. Thus, it is no longer necessary for all parts to be exactly fixed for being able to represent the spatial arrangement of the complete machine.

The CAD system in accordance with the present invention is particularly suited for implementation as a system having a plurality of work stations. At least one work station is assigned to one of the groups in such a way that the addition, changing or removal of layout elements of the group is possible at this work station, while this is not possible at a work station not assigned to this group. This permits the division of the design of a complex machine into a plurality of partial tasks, each one of which corresponds, from the perspective of the designer, to a structural group of the machine or, from the perspective of the CAD system, to a replacement layout element. An employee charged with the design of the respective structural group can access the layout elements of this structural group, while other employees, who are responsible for other structural groups, or a design leader, can only access this group for reading.

### BRIEF DESCRIPTION OF THE DRAWINGS

Preferred embodiments of the invention are represented in the drawings and will be described in greater detail in what follows.

Shown are in:

FIG. 1, a schematic representation of a computer network representing a CAD system, in

FIG. 2, a schematic representation of a data structure in a memory of the CAD system, in

FIGS. 3 to 5, the development of the data structure in the course of the design process, in

FIG. 6, a block representation of the data structure being created in the course of the design process, in

FIG. 7, a variation of the data structure in FIG. 6, in

FIGS. 8 to 10, a first preferred embodiment of the variation of the data structure in FIG. 7, and in

FIGS. 11 to 13, a second preferred embodiment of the variation of the data structure in FIG. 7.

### DETAILED DESCRIPTION OF THE PREFERRED EMBODIMENTS

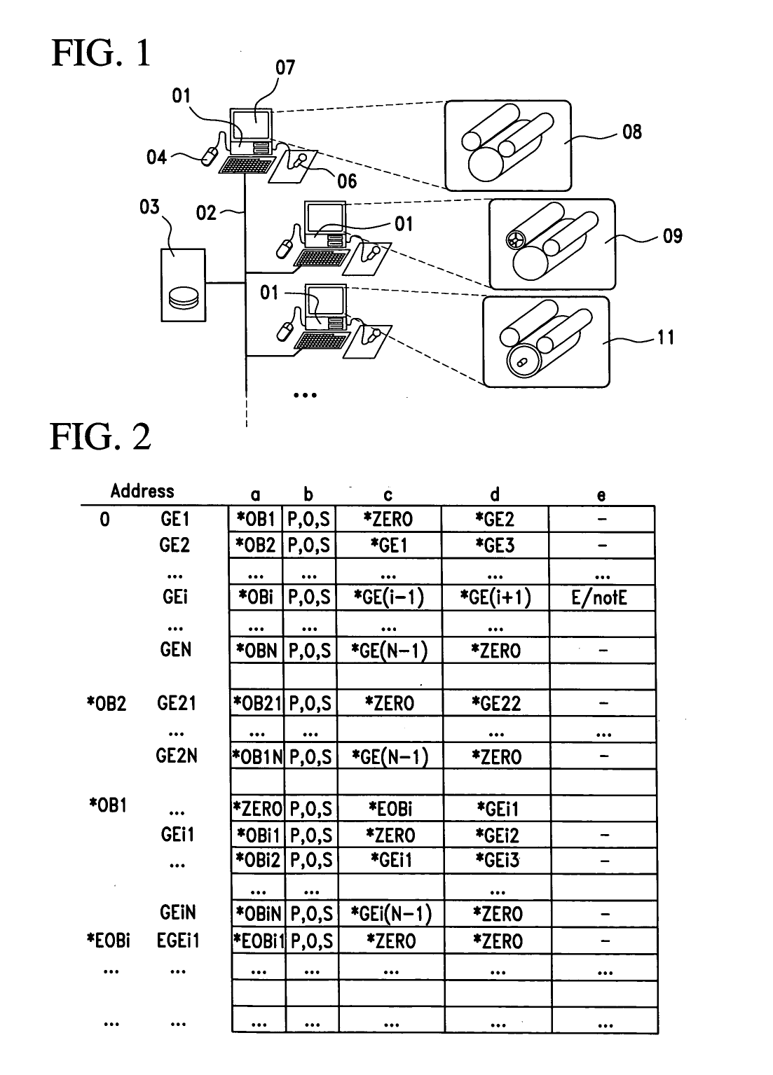

A computer network is represented in FIG. 1 that includes a plurality of work station computers 01, each of which is equipped with its own processor (not represented) and, via a network data line 02 of any arbitrary topology, accesses a common memory 03 containing, inter alia, data describing the object to be designed at the work station computers 01. Each work station computer 01 is equipped with input devices 04, 06, for example a mouse 04, or a digitizer 06, which make possible the rapid input of coordinate values. Moreover, each work station computer 01 includes a display device 07, for example a display screen 07, for displaying a graphic representation calculated in the processor of a complex object, which is designed by a plurality of employees together at the individual work station computers 01, or parts thereof.

The design work of the individual employees substantially consists of the successive input of objects into the work station computer 01, which are stored in the form of data sets, here called layout elements. Each of the layout elements contains the identification of an object to be inserted into the design, information regarding its position and orientation in relation to a given coordinate system and, if needed, scaling information.

The object of a layout element can be elementary or composite. An object is called elementary if the CAD system has a sub-program for calculating a graphic representation of the object. Elementary objects can be, for example, straight lines, rectangles, ellipses or, in three-dimensional design, simple spatial objects, such as cubes, pyramids, cylinders, ellipsoids, etc. The input of a layout element takes place by selecting the type of an object to be input, such as a straight line, ellipse, etc., by selecting from a menu of objects output by the processor on the display screen and subsequent input of the coordinates of defined points of the selected object.

However, the design work is considerably simplified and made more efficient by the possibility of defining composite layout elements and introducing them in the course of drawing. A composite layout element is defined in that a user inputs a plurality of objects, which can be elementary or themselves also composite, into the work station computer 01, or makes a selection from already input objects, and assigns a name to this group which thereafter, in the same way as the names of the elementary objects, is displayed by the system in a menu of symbols and can be selected by the user.

FIG. 2 shows an example of the contents of the memory 03 during a design process, using elementary and composite objects. Each line of the diagram in FIG. 2 here corresponds to a layout element. Each layout element is composed of five data fields, identified by the letters “a” to “e” in FIG. 2.

The first data field “a” of each layout element has the format of a pointer to a memory location in the memory 03. Once the layout element has been put together, the data field “a” actually contains a pointer to that address in the memory 03 where the first of the layout elements is located of which the composite object consists. If the layout element is elementary, the data field “a” can contain a pointer to a sub-program for drawing the elementary object or a numerical value, which does not correspond to a valid address and is representative of the type of the object.

The second data field “b” of each layout element respectively contains information P, O, S regarding the position, orientation and scaling of the object. If necessary, the second data field also contains further parameters, such as line thickness, line pattern, etc.

The third data field “c” respectively contains a pointer to a precursor layout element. No such precursor exists in the case of the first layout element GE1, and the data field “c” has the value NULL; for example in the second layout element GE2 it is a pointer to GE1.

The fourth data field “d” respectively contains a pointer to the subsequent layout element, in the case of GE1 therefore a pointer to GE2.

The fifth data field “e” has no function in an elementary or composite layout element; its task will be explained at a later time.

In the example of FIG. 2 it has been assumed that the layout element GE2 is a composite. Therefore its data field “a” contains a pointer *OB2 to the first layout element GE21 of a group of layout elements GE21 to GE2N, which constitute the object OB2. The structure of this group of layout elements is the same as with the group of elements GE1 to GEN.

The layout element GE1 is also a composite. In this layout element, the pointer *OBi in the data field “a” does not point to the first layout element GEi1 of the object OBi, but to a data structure which is here called a branch structure and wherein the type information in the data field a has the value *NULL. This value cannot occur in connection with a layout element, it is used by the system as a differentiation characteristic between layout elements and branch structures. The second data field “b” of the branch structure is unused, the third data field “c” contains a pointer *EOBi, and the fourth data field “d” a pointer *GEi1. *GEi1 is a pointer to the first layout element GEi1 of the object OBi. *EOBi is a pointer to a so-called replacement object of the object OBi.

When calculating a graphic representation of the layout element GEi, the value of the fifth data field “e” is evaluated, which can assume two different values, E or _{┐}E (replacement layout element or not replacement layout element). If the data field “e” has the value _{┐}E, the system uses the pointer *GEi1 in the data field “d” for drawing the object OBi, and in this way sequentially processes the layout elements GEi1 to GEiN of the object OBi, i.e. the layout element GEi is displayed with all details of the layout elements GEi1 to GEiN of which it is composed.

If the data field “e” of the branch structure GEi has the value E, the replacement object EOBi is drawn in place of the object OBi, which in the present example only consists of a single layout element EGEi 1. But the replacement object EOBi could of course also consist of several layout elements, which are linked by respective pointers pointing to each other in their data fields “c”, “d” in an analog fashion as described above.

Use of the replacement layout elements considerably simplifies the top-down design of a complex object, as well as the work-related design. This will now be explained in a simplified way though use of the example of the design of a printing press.

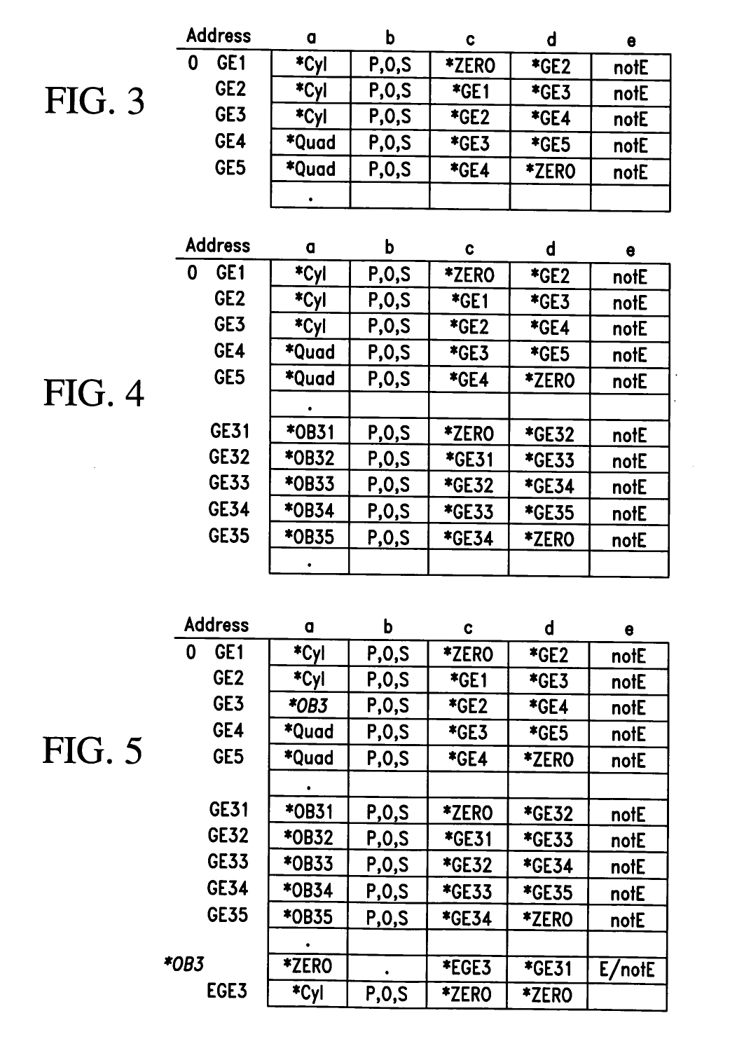

In a very rough simplification a printing press can be considered to be an arrangement of a plurality of cylinders between two lateral frame plates. Therefore a first stage of the design process of the press can consist in that initially these greatly simplified elements are designed, i.e. the respective layout elements are entered into the memory 03. The result is a memory content as represented in FIG. 3 by way of example, having five layout elements GE1 to GE5, among them three cylinders, each representing a roller of the printing press, and two cube- or prism-shaped layout elements for the frame plates.

The data fields a of each one of these layout elements therefore each contain an address value *Zyl, or *Quad, which corresponds to the sub-program of the CAD system for drawing a cylinder or a cube.

Now, for designing a roller in detail, a designer enters a command for creating a new group in the system. Following this, the system deposits layout elements GE31 to GE35, input by the designer, of the group opened in this way, in an area of the memory as data structures linked to each other by pointers, in the same format as the layout elements GE1 to GE5.

After the user has issued a command for closing the group, there are different options for linking the layout elements of the group with the layout elements GE1 to GE5.

Assuming that the group of layout elements GE31 to GE35 are intended to replace the layout element GE3, a first simple option, not represented in a drawing figure, is to replace the pointers *GE3 in the layout elements GE2 and GE4 by *GE31 or *GE35, and to replace the zero pointers of GE31 and GE35 by *GE2 or *GE4. In the graphic representation, this corresponds to a simple substitution of the layout element GE3 by its detailed representation in the form of the layout elements GE31 to GE35.

Another option is that, when closing the group, the user gives it a name, for example “Object1”, and that the system includes this name in a menu of selectable objects to be drawn and assigns it a pointer *GE31 to the first object of the group. In order to permanently include the group GE31 to GE35 in the graphic representation of the design object in place of the layout element GE3 it suffices to replace the pointer *Zyl in the data field “a” of the layout element GE3 by *GE31. This method also permits the replacement of other layout elements from the group GE1 to GE5 by the layout element composed of GE31 to GE35, in that a corresponding change of the pointer in the data field “a” of these other layout elements is performed.

A third option is represented by means of FIG. 5, which in a way analogous to FIGS. 2 to 4 represents the contents of the memory 03. If the user defines the original layout element GE3 as a replacement layout element of the group GE31 to GE35, the system deposits a branch data structure as represented in FIG. 2, whose data field “d” contains a pointer to GE31 and whose data field “c” contains a pointer to an also newly established layout element EGE3, at an address *OB3 of the memory. The corresponding data of the original layout element GE3 is copied into the data fields “a”, “b” of the layout element EGE3, and the data field “a” of GE3 is overwritten with a pointer *OB3.

The data field “e” of the branch data structure contains the statement E/_{┐}E which specifies whether the group GE31 to GE35 of layout elements, or the replacement layout element EGE3, is to be drawn for the layout element GE3. This statement can be changed by a user at any arbitrary time during the design process. This allows a user to make a selection at any time as to whether he would like to view the replacement layout element in a graphic representation, so that in this way he achieves a rapid image buildup, or whether he requires a detailed representation in which the entire group GE31 to GE35 is evaluated.

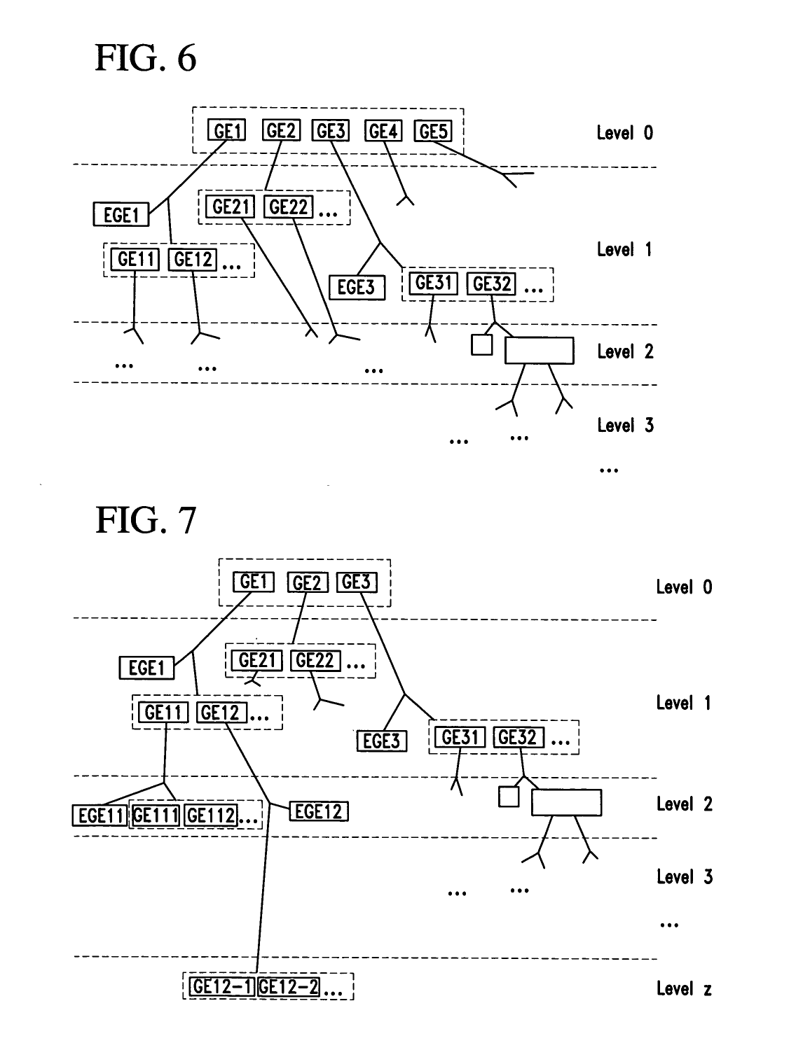

It is of course possible in the same way as described above to make layout elements of the group GE31 to GE35 into replacement layout elements for a later defined group. A tree-like structure of the design data is achieved in this way in the course of the design process, such as represented in FIG. 6. A base group of layout elements, in the example considered the layout elements GE1 to GE5 of the three rollers and the frame plates, constitutes the root of the tree on a level 0. Each layout element of this root is the starting point of a branch leading to a replacement layout element EGE1 or EGE3, as well as to a group of layout elements GE11, GE12, . . . , or GE31, GE32, . . . , or only to a group such as G21, G22, . . . , without an assigned replacement layout element, of a next lower level 1, which represent individual structural groups of the part of the design object represented by GE1, GE3, or GE2. Branching continues over a practically arbitrarily number of levels as far as to layout elements which are either elementary, or which represent descriptions of standard structural elements contained in a library.

The data field “e” of the above described data structures makes it possible, by setting the statement E/_{┐}E, to individually determine for each group of layout elements to which a replacement layout element has been assigned whether the graphic representation should be detailed or should only represent the respective replacement layout element.

Another option for fixing the details of the graphic representation is explained by means of FIG. 7. The root of the tree structure on the level 0 here contains, for example, the layout elements GE1, GE2, GE3. On a next lower level 1 a replacement layout element EGE1 and a group of layout elements GE11, GE12, . . . , are assigned to the layout element GE1, which can be selectively represented instead of the replacement layout element EGE1. Again, the replacement layout element EGE11 and a group of layout elements GE111, GE112, . . . , on the next lower level 2 correspond to the layout element GE11.

The system offers an option to the user to specify a level, called a resolution level, up to which replacement layout elements, instead of a detailed representation of the graphic representation, are made the basis. This means that if the user specifies the level 1 as the resolution level, the graphic display is generated on the basis of the replacement layout element EGE1, as well as other replacement layout elements present on this level. For displaying the layout elements GE21, GE22, to which no replacement layout element corresponds on the level 1, the tree must be traced to a lower level where, if provided, the calculation of the representation by taking a replacement layout element into consideration can be stopped, or the tree ends with an elementary layout element.

The selection of the resolution level is effective for all layout elements. Therefore, in the case represented, for GE3 the replacement layout element EGE3 present on the level 1 selected as the resolution level is also represented.

If a user wants to have a representation which is more detailed by one level, and therefore selects the level 2 as the resolution level, EGE1 will not be represented. Instead, the group GE11, GE12 of layout elements represented by this replacement layout element is further traced in the tree structure. Thus, for example, the system selects a replacement layout element EGE11 for the layout element GE11 and a group of alternatively representable layout elements GE11, GE112, . . . , on the level 2. The replacement element EGE11 is used for the graphic representation.

Only a replacement layout element EGE12 exists for the layout element EG12 on the level 1; a group of layout elements GE12-1, GE12-2, . . . , represented by this replacement layout element has been placed on a lower hierarchic level z. In principle, this level can be any arbitrary level of the tree structure, but in particular is a lower level in which exclusively elementary layout elements, or references to layout descriptions of standard structural elements are settled in a library. As long as level 2 has been selected as the resolution level, replacement layout element EGE12 settled on the level 2 is represented, the same as with the branch extending from GE11. However, if the user selects a representation which is more detailed by one level, the system tracks the branches extending from GE111, GE112 and checks whether replacement layout elements which could be represented for these elements are present on the level 3 and if so, represents them. However, in the case of the branch extending from GE12, the level 3 is empty. Therefore, in this case the representation of the replacement layout element EGE12 on the level 2 remains, even if the level 3 has been selected as the resolution level.

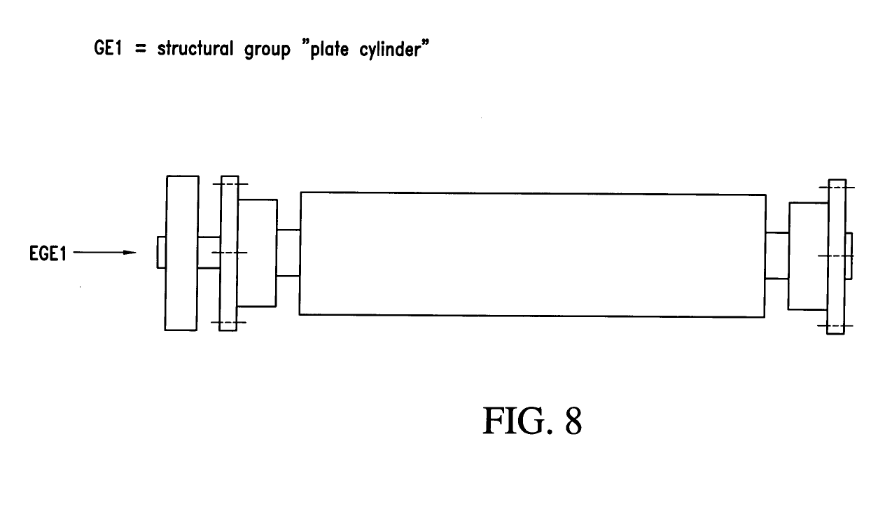

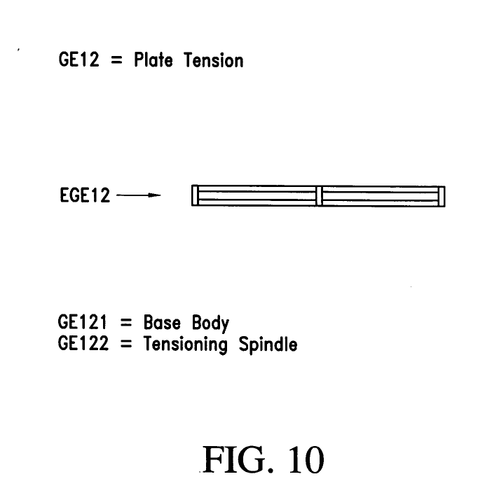

A first exemplary embodiment of the data structure shown in FIG. 7 is represented in FIGS. 8 to 10.

In FIG. 8 the layout element GE1, in which the structural component, the plate cylinder, is stored, is located on the level 0 (FIG. 7).

To this are respectively assigned a first group of internal information for designing the object itself to be designed (i.e. internal information regarding the structural component), and a second group of external information for connecting/inserting the later designed object, or the present replacement layout element (EGE1) with adjoining objects (i.e. interface information regarding adjoining elements).

Internal structural component information can be, for example, information regarding gear wheel sizes and/or information regarding the position and dimensions of the bearing sites. Interface information regarding adjoining elements can be, for example, information regarding the required structural space, the diameters of the bearing bushings, or drilling location information for both lateral walls.

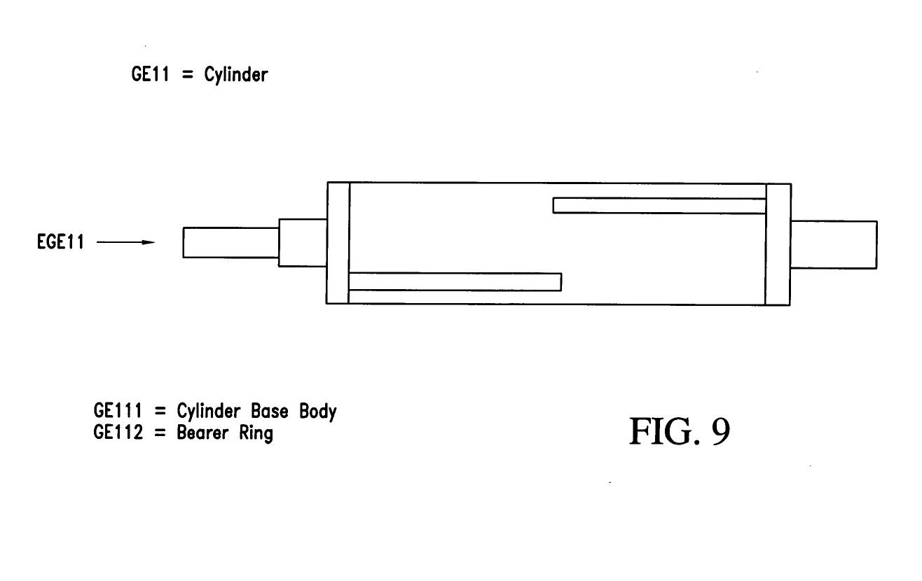

Thereafter, this structural element is stored as a replacement layout element (EGE1). Access to this element containing essential information for designing other structural elements or units, is now already available to other designers. As FIG. 9 shows, it is now possible to further process the cylinder identified as the base element GE11 and located on the level 1, for example, for determining grooves in the cylinder. Data regarding the required structural space, the position and dimensions of the grooves, or the journal diameter at the bearing site, for example, is stored as interface information for adjacent elements. The diameter and the width of the bearer rings, for example, are considered to be internal structural component information.

This structural element containing the new internal or external information is now stored on the level 2 (FIG. 7) as the replacement layout element EGE11, so that information can also be called up here by all users of the program.

Thereafter the layout elements GE111=basic cylinder body, or GE112=bearer rings, can be available for further processing.

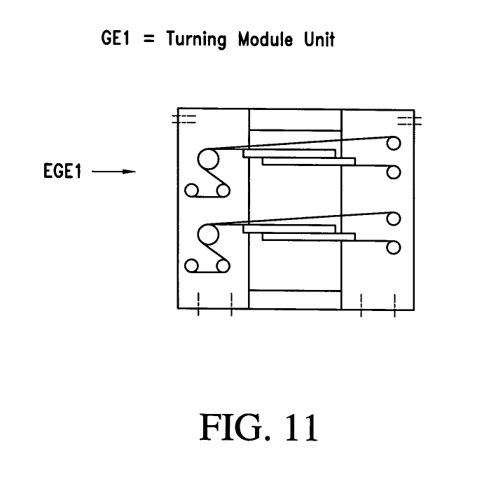

A second exemplary embodiment is represented in FIGS. 11 to 13. As shown in FIG. 11, a turning module unit is available for selection on the level 1 in the form of a layout element GE1. In this case it is possible to fix the required structural space, the clearance, or connecting options, for example, as interface information with adjoining elements. The position and diameter of the rollers, and/or the shape of the lateral walls, for example, are fixed as unit-internal information. After processing the internal and external information, the structural element is now stored as replacement layout element EGE1.

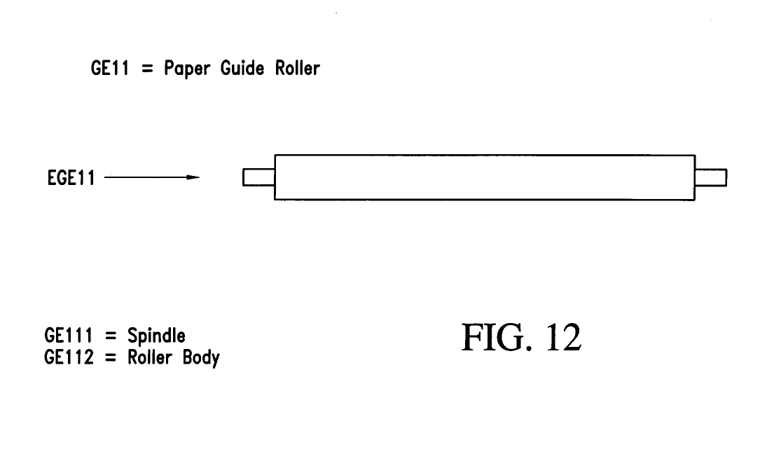

Following this, the layout element 11, which is represented in FIG. 12 as a paper guide roller, can be processed. The required structural space and the length of the roller, for example, can be the interface information with adjoining elements. The dimensions and/or the bearing sites, for example, can be stored as internal structural component information.

Thereafter, the paper guide roller designed in this way is stored in the form of a replacement layout element EGE1.

Spindles or roller bodies, for example, can then be stored on the next lower level as layout elements G111 or G112.

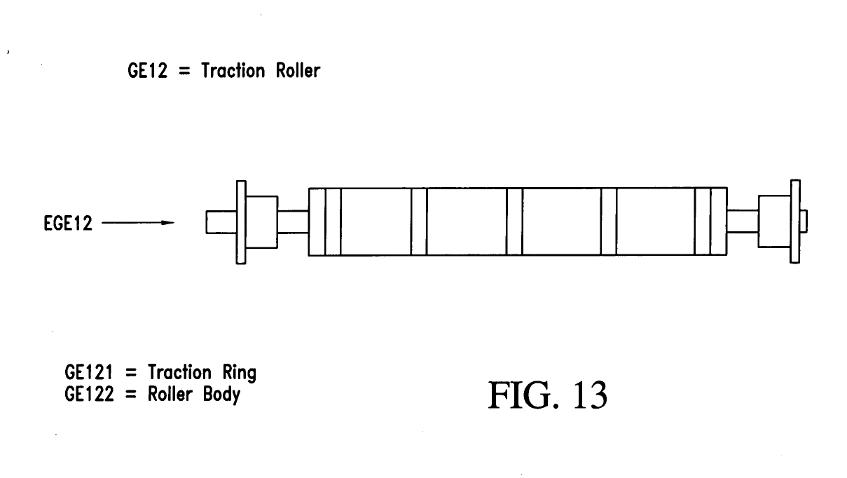

In accordance with FIG. 7, the layout element GE12 represented in FIG. 13 and represented as a traction roller, is located on the same level as the layout element GE11.

Now interface information with adjoining elements, such as required structural space, diameter and length of the roller, or the diameter of the bearing, is assigned to this traction roller. Data regarding the position and diameter of the traction rings or regarding the journal dimensions, for example, can be data for the information internal to the structural group.

This structural element is also stored as a replacement layout element EGE12.

It should also be noted that the replacement layout elements EGEi each contain only a portion (basic information) of the geometry information of the later designed detailed object.

The assignment of layout elements or groups of layout elements to a defined level of the tree structure can be arbitrarily made by the user, or it can also be performed in accordance with predetermined rules by the CAD system itself. For example, it can be provided that all layout elements which are elementary or correspond to standard structural elements taken from a library, are settled on a lowermost level of the tree structure. In this manner, they only appear in detail in the graphic representation if either a user selects a representation with maximum detail contents, or if these layout elements of the lowermost level do not belong to a group to which a replacement layout element has been assigned on a higher level.

It can be practical not to assign a replacement layout element on a higher level in particular for those elementary or library layout elements which are important for the connection of structural groups with each other and should therefore be always visible to all users engaged in the design of these structural groups.

In the tree structure in FIG. 7, replacement layout elements, such as EGE1, EGE3, and the groups GE11, GE12, . . . , or GE31, GE32, . . . , assigned to them are each arranged on the same level 1 of the tree structure. However, this is nothing more than a logical convention. The same operation of the CAD system could also be realized if the replacement layout elements were all settled one level higher in the tree structure than the associated groups.

If the selection of a resolution level is used as the alternative to the use of the data field “e” for establishing the wealth of details in the graphic structure, the data field “e” can be omitted in the data structures of the individual layout elements. However, both methods can also be employed in combination, in which case it must be established which of the two uses has preference over the other. It is particularly practical to give the statement E/_{┐}E preference over the selected resolution level. If in the branch structure of an object the value _{┐}E is inserted in the data field “e” by a user, the representation of the object by a replacement layout element is prohibited, and it must be shown in detail regardless of the selected resolution level. But if the data field “e” has the value E, the representation of the object by a replacement layout element is permitted, and whether the replacement layout element is actually shown depends on the resolution level selected. If the replacement layout element is located on the selected resolution level, it is represented; if it is located above it, the tree structure on the next lower level will be further traced instead.

In a CAD system with several work stations 01, where several designers need to access the same data (layout elements) regarding a complex object to be designed, the data field “e” of each branch structure preferably contains several bits, each of which is assigned to a work station, so that all work stations can access a single set for read-out independently of each other, while it is yet possible to switch between a detailed representation and a representation of a replacement layout element at each work station independently of the others.

This makes it possible for each designer working at one of the work station computers 01 to set, starting with the layout description in the memory 03 which is uniform for all, a representation on his display screen 07 in accordance with his needs, in which the structural groups relevant to him are shown in detail, while the replacement layout elements for structural groups which are of less importance to him are visible. FIG. 1 illustrates this by means of the enlarged representations 08, 09, 11 of the display screens 07. While in the enlargement 08 three rollers of the printing press are represented by replacement layout elements in the form of simple cylinders, each of the enlargements 09, 11 shows one of these rollers to the responsible designer in detail.

In connection with such a multi-station CAD system in particular it can be useful if the data field “a” of a composite layout element can not only contain a pointer to the address of the memory 03, where the description of the composite layout element starts, but alternatively also the identification of a data set of an appropriate content. Making use of the functions of an operating system on which the CAD system is based, this makes the control of the access authorization of the individual work stations to the representations easier. If only a selected one of the work stations is charged with the design of the structural component described in the data set is given the authorization to make entries in a data set, then although the contents of the data set can be read out at all work stations of the system and taken into consideration in the design of the structural components to be designed there, changes in the design of the structural components described in the data set can only be made at the selected one of the work stations.

It is obvious that the above described data structures are only one example among many, by which the essential goal of the invention can be reached. This goal is to be able at any arbitrary time in the course of a design process to determine for any arbitrary structural groups of the design object to which degree of detail these are to be represented. While in the above described example layout elements and branch structures are each stored as coherent data structures in a common memory 03, it can make sense, for example, that the CAD system manages the data fields “a” of the branch structures in the form of data sets which are separated from the remaining layout description. This will make it easier to assure that at each work station computer 01 the data field “e” assigned to it can be read and written, while at other parts of the branch structure it is only permitted to write from the work station computer at which the structural component, of which the branch structure is a part, is being designed.

In what follows, a method for designing a machine composed of several structural groups or objects will be described. First, a replacement layout element (EGEi), which represents the object to be designed in a simplified manner, is determined for at least one object to be designed, information regarding the geometry of the object to be designed are assigned to this replacement layout element (EGEi), and an object of greater detail is designed by means of the replacement layout element (EGEi) and/or its associated information.

Thus, at least one piece of information regarding the geometry of adjacent objects, for example connection dimensions, is assigned to the replacement layout element (EGEi), so that the required structural space, for example, can be assigned. Moreover, at least one diameter value, but preferably two diameter values, can be assigned to the information.

A first group of pieces of internal information for designing the object to be designed itself, and a second group of pieces of external information for connecting/inserting the later designed object, or the present replacement layout element (EGEi) with adjoining objects, are assigned to the replacement layout element (EGEi).

At least one further replacement layout element (EGEi) can be inserted into the replacement layout element (EGEi).

For representation, the replacement layout element (EGEi) can be shown three-dimensionally.

The replacement layout element (EGEi) can be determined to be a rotatory body, wherein at least one diameter value can be assigned to the replacement layout element (EGEi). By means of the diameter value it is possible to design a barrel of the rotatory body at least in part. It is possible by means of a second diameter value which can be assigned to the replacement layout element (EGEi) to design, for example, a journal and/or a bearing site of the rotatory body. It is moreover possible to assign a length to the rotatory body, as well as the position and dimensions of at least one bearing site. A bearing between the replacement layout element (EGEi) and the adjoining object can be described by means of the second diameter value.

A printing press can be designed by means of the replacement layout element (EGEi). In this regard, numerous objects or structural components of the printing press can be represented by the replacement layout element (EGEi). These include, for example, at least one unit, at least one printing unit, at least a turning module, at least one roll changer, at least one folding apparatus, at least one roll support, at least one module of a roll support, at least one roll-transporting vehicle, at least one support element of a printing press, a rail element for guiding a roll-transporting vehicle, a processing station for rolls of material, a machine for the further processing of printed products, in particular folded printed products, at least one gripper element for picking up printed products or a module of a machine for further processing of printed products.

As another example, a printing unit can be represented by means of the replacement layout element (EGEi) and, within this replacement layout element (EGEi), a printing cylinder or an inking roller can be represented by means of a plurality of replacement layout elements (EGEi).

It is possible to selectively represent the detailed object, or its associated replacement layout element (EGEi).

It is also conceivable to link the information from several replacement layout elements (EGEi).

Although the present invention has been disclosed in terms of a number of preferred embodiments and variations thereon, it will be understood that numerous additional variations and modifications could be made thereto without departing from the scope of the invention as defined in the following claims.

1-54. (Cancelled).

55. A CAD system for supporting the design of a machine composed of several structural groups, said system comprising:
at least a first processor;
at least a first display device interfaced to said processor for displaying one or more structural objects of a machine to be designed;
a memory interfaced to said processor, said memory containing a plurality of layout elements each for forming one or more structural objects to be displayed on said display device; and
a program run by said processor for designing structural objects for a machine by carrying our the steps of:
for at least one object to be designed, identifying a first replacement layout element in said memory which shows the object to be designed in a simplified form on said display device;
assigning information regarding the geometry of said object to be designed to said
replacement layout element; and
constructing a more detailed version of said object to be designed through use of the replacement layout element and/or its assigned information, wherein a group of layout elements is assigned to said replacement layout element in the course of the design of said object.

56. The CAD system of claim 55, wherein information regarding the geometry of one or more objects that are adjacent to said object to be designed is assigned to the replacement layout element.

57. The CAD system of claim 55, wherein a first group of internal information for designing the object to be designed itself, and a second group of external information for connecting/inserting the later designed object, or the present replacement layout element, to one or more adjoining objects, is assigned to the replacement layout element.

58. The CAD system of claim 55, wherein at least a second replacement layout element is inserted into the first replacement layout element.

59. The CAD system of claim 55, wherein the replacement layout element is three-dimensionally reproduced as a replacement body.

60. The CAD system of claim 55, wherein the replacement layout element is selected to be a rotatory body.

61. The CAD system of claim 60, wherein at least one diameter value is assigned to the replacement layout element and a barrel of the rotatory body is designed through use of the diameter value.

62. The CAD system of claim 61, wherein at least a second diameter value is assigned to the replacement layout element and wherein a journal of the rotatory body is designed through use of the second diameter value.

63. The CAD system of claim 60, wherein at least one length is assigned to the rotatory body.

64. The CAD system of claim 60, wherein a position and dimension of at least one bearing site are assigned to the rotatory body.

65. The CAD system of claim 55, wherein at least one diameter value is assigned to the replacement layout element.

66. The CAD system of claim 65, wherein at least a second diameter value is assigned to the replacement layout element.

67. The CAD system of claim 56, wherein the required structural space for the object to be designed is assigned to the replacement layout element.

68. The CAD system of claim 56, wherein at least one diameter value is assigned to the replacement layout element.

69. The CAD system of claim 68, wherein at least a second diameter value is assigned to the replacement layout element.

70. The CAD system of claim 69, wherein a bearing between the object to be designed and an adjoining object is described by the second diameter value.

71. The CAD system of claim 55, wherein a printing press is designed through use of the replacement layout element.

72. The CAD system of claim 55, wherein at least one object is represented through use of the replacement layout element, said at least one object being selected from the group comprising: at least one printing unit, at least one turning element, at least one roll changer, at least one folding apparatus, a roll support for a printing press, at least one module of a roll support, at least one roll-transporting vehicle, at least one support element for receiving rolls of material, a rail element for guiding a roll-transporting element, a processing station for rolls of material, a machine for further processing of printed products, in particular folded printed products, at least one gripper element for picking up printed products, and a module of a machine for further processing of printed products.

73. The CAD system of claim 55, wherein a printing unit is represented through use of the replacement layout element, and inside this replacement layout element of the printing unit, a printing cylinder and/or an inking roller are represented through use of a plurality of additional replacement layout elements.

74. The CAD system of claim 55, wherein said program allows selective display of either said replacement layout element or a layout element that displays said object to be designed in greater detail.

75. The CAD system of claim 56, wherein the information from several replacement layout elements is linked.

76. The CAD system of claim 56, wherein a build-up of a machine to designed is first determined in a rough layout through use of the input of said replacement layout element.

77. A CAD system for aiding the design of an object composed of several structural groups, comprising:
at least one input device for inputting a layout description of the object, wherein the layout description comprises a plurality of layout elements;
at least one processor for calculating a graphic representation of the object from the layout description of the object;
at least one display device for displaying a representation of the object calculated by the processor; and
a program run by said processor for carrying out the functions of:
1) assigning the layout elements of the layout description in a tree-like structure with several levels to a plurality of groups;
2) assigning a replacement layout element to several of these groups on different levels;
3) assigning to said replacement layout element, a first group of internal information for designing the object to be designed itself, and a second group of external information for connecting/inserting the later designed object, or of the present replacement layout element to one or more adjoining objects; and
4) selectively taking into account in the course of calculating a representation of at least one of said groups, a totality of the layout elements assigned to the group, or the replacement layout element assigned to the group.

78. The CAD system of claim 77, wherein said program performs the assignment of one or more layout elements to a group in response to instructions input by a user.

79. The CAD system of claim 78, wherein said program later assigns each previously input layout element to a group.

80. The CAD system of claim 79, wherein the program opens a group of layout elements upon the instruction of a user, and assigns the layout elements which are input while said group is open to said group.

81. The CAD system of claim 77, wherein the program assigns a replacement layout element to a group in response to instructions input by a user.

82. The CAD system of claim 81, wherein said program generates a group assigned to the replacement layout element in response to each input of a replacement layout element and/or the input of a declaration of an already input layout element.

83. The CAD system of claim 77, wherein the layout description of said object includes a multitude of layout descriptions of layout elements and/or other objects, which are parts of said object.

84. The CAD system of claim 77, further comprising a plurality of work station computers, each comprised of at least one input device and a display device, wherein at least a first of the work station computers is assigned to one of the groups in such a way that an addition, change or removal of layout elements of the group is only possible at said first work station.

85. The CAD system of claim 77, wherein said program, in response to receiving the input of layout elements of the object into the CAD system, wherein a plurality of the input objects forms a group, and one of the input layout elements is a replacement layout element of the group, carries out the steps of:
determining whether in the course of calculating the representation of the object the replacement layout element or the totality of the group is to be made the basis;
calculating a representation of the object of the determination; and
displaying the representation on said display device.

86. The CAD system of claim 85, wherein in response to receiving a command for opening a group, the program assigns layout elements received after receipt of said command to said group, but ceases assigning layout elements to said group after a command to close said group is received.

87. The CAD system of claim 85, wherein said program, in response to a command, combines a selection of layout elements already previously input into a group.

88. The CAD system of claim 85, wherein said program assigns the group to an already input layout element, which thereby becomes the replacement layout element of the group.

89. The CAD system of claim 85, wherein the object is a complex machine comprised of a plurality of structural groups, a group of layout elements respectively represents a description of one of the structural groups, and the replacement layout element assigned to the group of layout elements approximates the physical layout of the structural group.

90. The CAD system of claim 77, wherein in response to receiving the input of a layout element approximating the layout of one of the structural groups and receiving the input of a group of layout elements which specify the details of the structural group, said program assigns the layout element which approximates the layout of the structural group to the group as a replacement layout element, determines whether in calculating the representation of the object the group of layout elements or the replacement layout element is to be made the basis, calculates a representation of the object of the determination, and displays the representation on said at least one display device.

91. The CAD system of claim 77, wherein several work station computers are provided which access an object, wherein each work station can be switched, independently of the other work stations, between a detailed representation and a representation of a replacement layout element of said object.

92. A CAD system for designing a machine composed of several structural groups, said system comprising:
at least a first processor;
at least a first display device interfaced to said processor for displaying one or more structural objects of a machine to be designed;
a memory interfaced to said processor, said memory containing a plurality of layout elements each for forming one or more structural objects to be displayed on said display device; and
a program run by said processor for designing structural objects for a machine by carrying our the steps of:
for at least one object to be designed, identifying a first replacement layout element in said memory which shows the object to be designed in a simplified form on said display device;
assigning information regarding the geometry of said object to be designed to said replacement layout element;
constructing a more detailed version of said object to be designed through use of the replacement layout element and/or its assigned information;
following the definition of the replacement layout element, designing said replacement layout element itself into a layout element with greater detail, wherein information regarding the geometry of one or more adjoining objects is assigned to the replacement layout element, said replacement layout element is determined to be a rotatory body, at least first and second diameter values are assigned to the information, a seating between the replacement layout element and an adjoining object is described through use of the second diameter value, a printing unit is represented through use of the replacement layout element, and inside said replacement layout element of the printing unit a printing cylinder or an inking roller are represented through use of a plurality of additional replacement layout elements.

93. The CAD system of claim 92, wherein a group of layout elements is assigned to each one of the replacement layout elements, which is filled with layout elements in the course of the design of the structural component corresponding to the replacement layout element.

94. The CAD system of claim 93, wherein the group of layout elements is still empty at the time of the input or the definition of the replacement layout element.
